(19) United States
(12) Patent Application Publication
(10) Pub. No.: US 2024/0312687 A1
(43) Pub. Date: Sep. 19, 2024

(54) MULTILAYER INDUCTOR

(71) Applicant: TDK CORPORATION, Tokyo (JP)

(72) Inventors: Takahiro Yata, Tokyo (JP); Masashi Shimoyasu, Tokyo (JP); Masataka Yamamoto, Tokyo (JP); Hiroyuki Abe, Yurihonjo-city (JP); Daiki Saito, Yurihonjo-city (JP); Akihiko Oide, Tokyo (JP)

(73) Assignee: TDK CORPORATION, Tokyo (JP)

(21) Appl. No.: 18/599,410

(22) Filed: Mar. 8, 2024

(30) Foreign Application Priority Data
Mar. 15, 2023 (JP) 2023-041086

(51) Int. Cl. H01F 17/00; H01F 17/04

(52) U.S. Cl. CPC H01F 17/0013; H01F 17/04; H01F 2017/0073

(57) ABSTRACT

A multilayer inductor includes: an element body having a pair of end surfaces facing each other, and a side surface extending in a facing direction of the pair of end surfaces in such a way as to connect the pair of end surfaces; and a through conductor disposed inside the element body and extending in the facing direction. The element body includes a first portion surrounding the through conductor and a second portion positioned outward of the first portion, when viewed in the facing direction. The first portion is disposed spaced from the side surface. The first portion and the second portion have different magnetic permeabilities from each other.

### TECHNICAL FIELD

The present disclosure relates to a multilayer inductor. This application claims priority based on Japanese Patent Application No. 2023-041086 filed on Mar. 15, 2023, the entire contents of which are incorporated herein by reference.

### BACKGROUND

A multilayer inductor including an element body having a pair of end surfaces, and a through conductor disposed inside the element body and extending in a facing direction of the pair of end surfaces is known (e.g., Japanese Unexamined Patent Publication No. H4-165606).

### SUMMARY

It is an object of the present disclosure to provide a multilayer inductor that is capable of improving DC superimposition characteristics.

A multilayer inductor according to one aspect of the present disclosure includes an element body having a pair of end surfaces facing each other, and a side surface extending in a facing direction of the pair of end surfaces to connect the pair of end surfaces, and a through conductor disposed inside the element body and extending in the facing direction, wherein the element body includes a first portion surrounding the through conductor, and a second portion positioned outward of the first portion, when viewed in the facing direction, wherein the first portion is disposed spaced from the side surface, and wherein the first portion and the second portion have different magnetic permeabilities from each other.

In the multilayer inductor above, the first portion of the element body surrounding the through conductor and the second portion of the element body positioned outward of the first portion have different magnetic permeabilities from each other. Thus, the distribution of magnetic flux density tends to be uniform, so that the DC superimposition characteristics can be improved. The first portion is disposed spaced from the side surface and is not exposed at the side surface, so that stretching of plating on the side surface is suppressed.

The magnetic permeability of the first portion may be lower than the magnetic permeability of the second portion. In this case, the DC superimposition characteristics can be reliably improved.

The element body may further include a third portion disposed between the first portion and the second portion, and the third portion may have a magnetic permeability that is higher than the magnetic permeability of the first portion and lower than the magnetic permeability of the second portion. In this case, impedance can be adjusted.

The element body may have a plurality of element body layers stacked in the facing direction. In this case, forming each of the element body layers by a printing method facilitates forming of the first portion and the second portion into desired shapes.

A length of the first portion in the facing direction may be equal to a length of the through conductor in the facing direction. In this case, the first portion can be provided along the entire length of the through conductor, so that the DC superimposition characteristics can further be improved.

The first portion may be disposed such that a longitudinal direction of the first portion follows along a longitudinal direction of the element body when viewed in the facing direction. In this case, the distribution of magnetic flux throughout the entirety of the element body is facilitated. Thus, the magnetic flux concentrates on a portion of the element body, so that magnetic saturation is suppressed. As a result, the DC superimposition characteristics can further be improved.

The pair of end surfaces may have a rectangular shape, and a length of the first portion in a long side direction of the pair of end surfaces may be greater than a length of the first portion in a short side direction of the pair of end surfaces. In this case, the distribution of magnetic flux throughout the entirety of the element body is facilitated. Thus, the magnetic flux concentrates on a portion of the element body, so that magnetic saturation is suppressed. As a result, the DC superimposition characteristics can further be improved.

The pair of end surfaces may have a square shape, and the through conductor and the first portion may each have a circular or square shape when viewed in the facing direction. In this case, the distribution of magnetic flux throughout the entirety of the element body is facilitated. Thus, the magnetic flux concentrates on a portion of the element body, so that magnetic saturation is suppressed. As a result, the DC superimposition characteristics can further be improved.

### BRIEF DESCRIPTION OF THE DRAWINGS

FIG. 1 is a perspective view illustrating a multilayer inductor according to a first embodiment.

FIG. 2 is a perspective view illustrating the multilayer inductor of FIG. 1.

FIG. 3 is a cross-sectional view illustrating the multilayer inductor of FIG. 1.

FIG. 4 is a cross-sectional view illustrating the multilayer inductor of FIG. 1.

FIG. 5 is a perspective view illustrating a multilayer inductor according to a second embodiment.

FIG. 6 is a cross-sectional view illustrating the multilayer inductor of FIG. 5.

FIG. 7 is a cross-sectional view illustrating a multilayer inductor according to a third embodiment.

FIG. 8 is a cross-sectional view illustrating a multilayer inductor according to a fourth embodiment.

FIG. 9 is a cross-sectional view illustrating a multilayer inductor according to a fifth embodiment.

FIG. 10A is a cross-sectional view illustrating a multilayer inductor according to a first comparative example.

FIG. 10B is a cross-sectional view illustrating a multilayer inductor according to a second comparative example.

FIG. 11 is a graph illustrating results of simulation of DC superimposition characteristics.

### DETAILED DESCRIPTION

Embodiments of the present invention will be described in detail below with reference to the accompanying drawings. Same reference signs are given to the same or corresponding elements in the description of the drawings, and redundant description will be omitted.

### First Embodiment

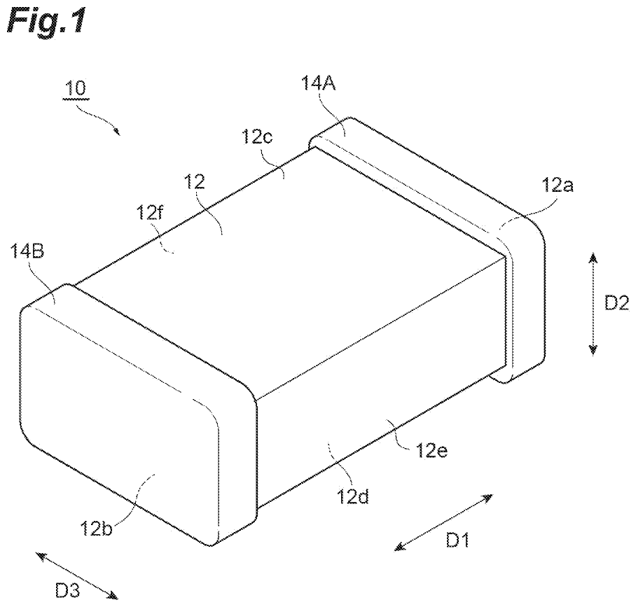

FIG. 1 is a perspective view illustrating a multilayer inductor according to a first embodiment. As illustrated in FIG. 1, a multilayer inductor 10 according to the first embodiment includes an element body 12, a pair of external electrodes 14A, 14B, and a through conductor 16.

The element body 12 has a rectangular parallelepiped external shape. The rectangular parallelepiped shape includes a rectangular parallelepiped shape in which the corners and edges are chamfered, and a rectangular parallelepiped shape in which the corners and edges are rounded. The element body 12 has, as its external surfaces, a pair of end surfaces 12a, 12b facing each other, a pair of side surfaces 12c, 12d facing each other, and a pair of side surfaces 12e, 12f facing each other. Each of the side surfaces 12c, 12d, 12e, 12f extends in a facing direction of the pair of end surfaces 12a, 12b so as to connect the pair of end surfaces 12a, 12b.

The side surface 12d is a mounting surface that faces a mounting substrate when the multilayer inductor 10 is mounted. The side surface 12c facing the side surface 12d becomes a top surface when the multilayer inductor 10 is mounted. Hereinafter, the facing direction of the pair of end surfaces 12a, 12b is a first direction D1, the facing direction of the pair of side surfaces 12c, 12d is a second direction D2, and the facing direction of the pair of side surfaces 12e, 12f is a third direction D3. The first direction D1, the second direction D2, and the third direction D3 are perpendicular to each other.

Assuming that the dimension of the element body 12 in the first direction D1 is a length, the dimension of the element body 12 in the third direction D3 is a width, and the dimension of the element body 12 in the second direction D2 is a thickness, the element body 12 has dimensions, for example, of length 2.5 mm×width 2 mm×thickness 0.85 mm. In this embodiment, the element body 12 is designed such that the width is greater than the thickness. The element body 12 is also designed such that the length is greater than the width. Each of the end surfaces 12a, 12b has a rectangular shape in which the second direction D2 is a short side direction and the third direction D3 is a long side direction.

The element body 12 has a plurality of element body layers (not shown) that are stacked in the first direction D1. That is, the first direction D1 is a stacking direction of the plurality of element body layers. In the actual element body 12, the plurality of element body layers are integrated such that the boundaries between the layers cannot be visually recognized. The number of the element body layers that form the element body 12 is, for example, 150. Each of the element body layers has a thickness (length in the first direction D1), for example, of 1 μm or more and 100 μm or less. The element body 12 is formed of a magnetic material such as ferrite. The element body 12 is obtained by stacking and firing a plurality of magnetic patterns to be the element body layers. The magnetic patterns are formed into a desired pattern by a printing method using, for example, a magnetic paste (e.g., ferrite paste). That is, the element body 12 has a printed multilayer structure.

The pair of external electrodes 14A, 14B are provided respectively on the pair of end surfaces 12a, 12b of the element body 12. The pair of external electrodes 14A, 14B are electrically connected to the through conductor 16. The external electrode 14A is provided on the end surface 12a and covers the entirety of the end surface 12a. The external electrode 14A integrally covers the end surface 12a and end portions of the side surfaces 12c, 12d, 12e, 12f adjacent the end surface 12a. The external electrode 14B is provided on the end surface 12b and covers the entirety of the end surface 12b. The external electrode 14B integrally covers the end surface 12b and end portions of the side surfaces 12c, 12d, 12e, 12f adjacent the end surface 12b.

Each of the external electrodes 14A, 14B is formed of one or a plurality of electrode layers. A metal material such as Ag or a resin electrode material may be employed as the electrode material that forms each of the external electrodes 14A, 14B. Each of the external electrodes 14A, 14B is formed including, for example, a sintered metal layer and a plated layer covering the sintered metal layer.

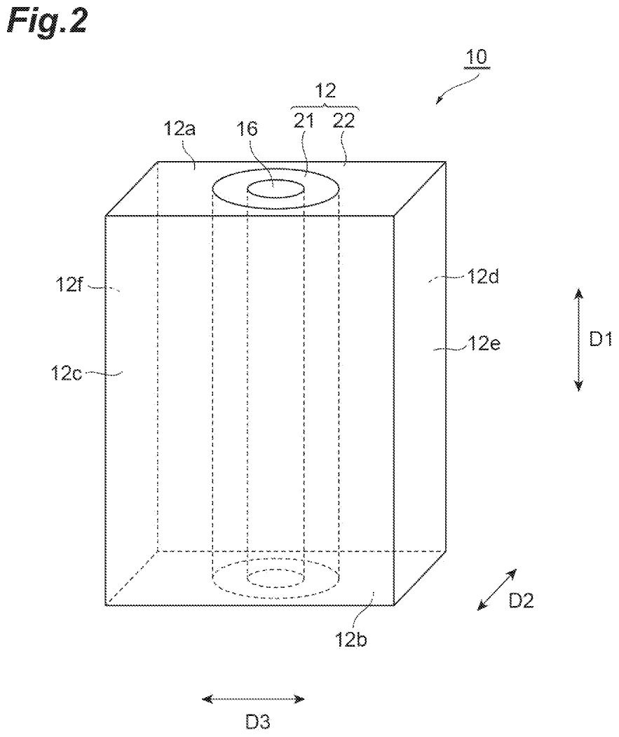

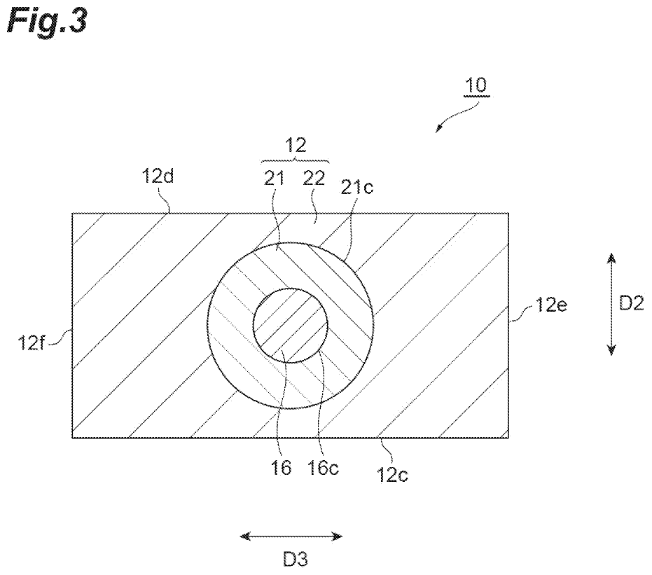

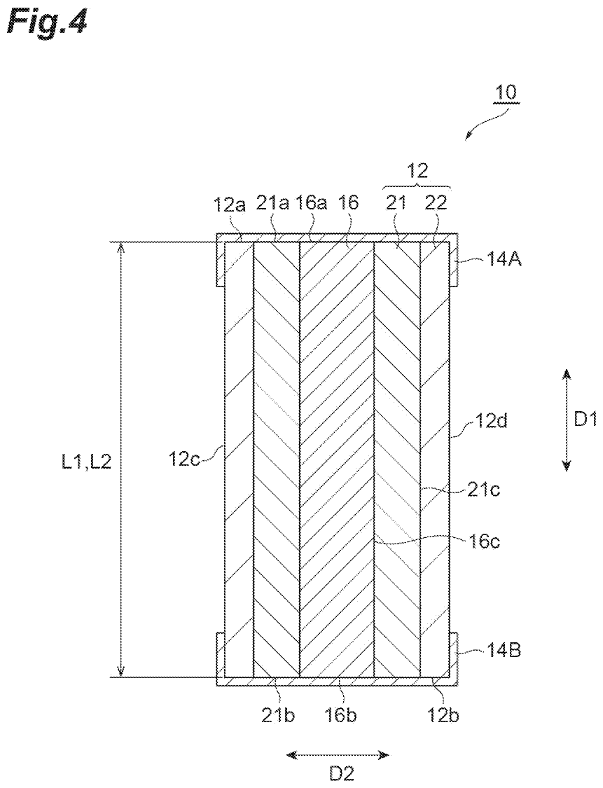

FIG. 2 is a perspective view illustrating the multilayer inductor of FIG. 1. Illustration of the external electrodes 14A, 14B is omitted in FIG. 2. FIGS. 3 and 4 are cross-sectional views illustrating the multilayer inductor of FIG. 1. FIG. 3 shows a cross-sectional view perpendicular to the first direction D1. FIG. 4 shows a cross-sectional view perpendicular to the third direction D3. As illustrated in FIGS. 2 to 4, the through conductor 16 is disposed inside the element body 12 and extends in the first direction D1. The through conductor 16 reaches from the end surface 12a to the end surface 12b. The through conductor 16 has a columnar shape in which the first direction D1 is an axial direction. The through conductor 16 has a diameter, for example, of 0.4 mm. A length L1 of the through conductor 16 in the first direction D1 is equal to the length of the element body 12 in the first direction D1.

The through conductor 16 has a pair of end surfaces 16a, 16b and a side surface 16c. The pair of end surfaces 16a, 16b face each other in the first direction D1. The end surface 16a is exposed at the end surface 12a and is bonded to the external electrode 14A. The end surface 16b is exposed at the end surface 12b and is bonded to the external electrode 14B. The side surface 16c extends in the first direction D1 so as to connect the pair of end surfaces 16a, 16b. The side surface 16c is an outer circumferential surface of the through conductor 16.

The through conductor 16 is disposed spaced from the side surfaces 12c, 12d, 12e, 12f, and is not exposed at the side surfaces 12c, 12d, 12e, 12f. The through conductor 16 is disposed in a center portion of the element body 12 in the second direction D2 and a center portion of the element body 12 in the third direction D3. That is, a separation distance between the through conductor 16 and the side surface 12c is equal to a separation distance between the through conductor 16 and the side surface 12d. A separation distance between the through conductor 16 and the side surface 12e is equal to a separation distance between the through conductor 16 and the side surface 12f. A separation distance herein refers to the shortest separation distance.

The through conductor 16 is formed of a conductive material including metal such as Ag. The through conductor 16 is formed, for example, by filling a through hole provided in the element body layers with a conductive paste and firing the same. The through conductor 16 may have a plurality of conductive layers (not shown) that are stacked together with the element body layers. In this case, the number of the conductive layers forming the through conductor 16 is the same as the number of the element body layers forming the element body 12. The through conductor 16 is obtained by stacking and firing a plurality of conductive patterns to be the conductive layers. The conductive patterns are formed into a desired pattern by a printing method using, for example, a conductive paste. That is, the through conductor 16 may have a printed multilayer structure similarly to the element body 12.

The element body 12 includes a first portion 21 and a second portion 22. The first portion 21 surrounds the through conductor 16 when viewed in the first direction D1. The first portion 21 is provided in contact with the side surface 16c. The first portion 21 is disposed spaced from the side surfaces 12c, 12d, 12e, 12f, and is not exposed at the side surfaces 12c, 12d, 12e, 12f.

The first portion 21 has a pair of end surfaces 21a, 21b and a side surface 21c. The pair of end surfaces 21a, 21b face each other in the first direction D1. The end surface 21a is exposed at the end surface 12a and is covered by the external electrode 14A. The end surface 21b is exposed at the end surface 12b and is covered by the external electrode 14B. The side surface 21c extends in the first direction D1 so as to connect the pair of end surfaces 21a, 21b.

The first portion 21 has a cylindrical shape inside of which the through conductor 16 is disposed and in which the first direction D1 is an axial direction. The side surface 21c is an outer circumferential surface of the first portion 21. The first portion 21 is disposed so as to be coaxial with the through conductor 16. The first portion 21 has an outer diameter, for example, of 0.7 mm. The first portion 21 covers the entire region of the side surface 16c with a uniform thickness.

The second portion 22 is disposed outward of the first portion 21 when viewed in the first direction D1. The second portion 22 surrounds the first portion 21 when viewed in the first direction D1. The second portion 22 is provided in contact with the side surface 21c of the first portion 21. The second portion 22 forms the entirety of each of the side surfaces 12c, 12d, 12e, 12f.

The first portion 21 and the second portion 22 have different magnetic permeabilities from each other. In this embodiment, the magnetic permeability of the first portion 21 is lower than the magnetic permeability of the second portion 22. A length L2 of the first portion 21 in the first direction D1 is equal to the length L1 of the through conductor 16 in the first direction D1.

As described above, in the multilayer inductor 10, the first portion 21 surrounding the through conductor 16 and the second portion 22 positioned outward of the first portion 21 have different magnetic permeabilities from each other. Thus, the distribution of magnetic flux density tends to be uniform, so that DC superimposition characteristics can be improved. The magnetic permeability of the first portion 21 is lower than the magnetic permeability of the second portion 22, so that the DC superimposition characteristics can be reliably improved.

If the first portion 21 is exposed at the side surfaces 12c, 12d, 12e, 12f in the case in which the pair of external electrodes 14A, 14B is formed including a plated layer, stretching of the plating may occur at the exposed portions. In the multilayer inductor 10, the first portion 21 is disposed spaced from the side surfaces 12c, 12d, 12e, 12f, and is not exposed at the side surfaces 12c, 12d, 12e, 12f. Consequently, stretching of the plating on the side surfaces 12c, 12d, 12e, 12f is suppressed.

The pair of end surfaces 21a, 21b is exposed respectively at the pair of end surfaces 12a, 12b. However, since the pair of end surfaces 21a, 21b is already covered by electrode layers (e.g., sintered metal layers) other than the plated layers of the pair of external electrodes 14A, 14B during the forming of the plated layers, the pair of end surfaces 21a, 21b do not have portions that come into contact with the plating. Consequently, stretching of the plating on the end surfaces 12a, 12b is suppressed.

The element body 12 includes the plurality of element body layers that are laminated in the first direction D1. Forming each of the element body layers by a printing method facilitates forming of the first portion 21 and the second portion 22 into desired shapes. Since the length L1 is equal to the length L2, the first portion 21 can be provided along the entire length of the through conductor 16 in the first direction D1. Consequently, the DC superimposition characteristics can further be improved.

### Second Embodiment

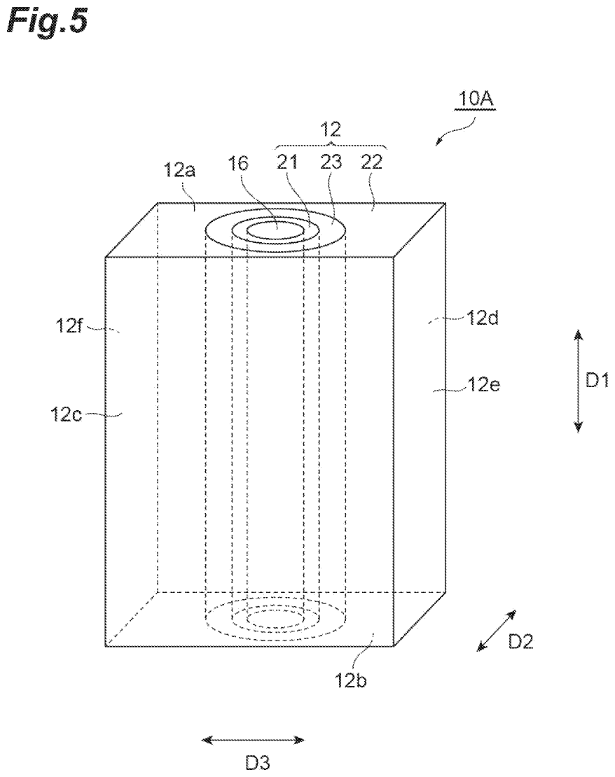

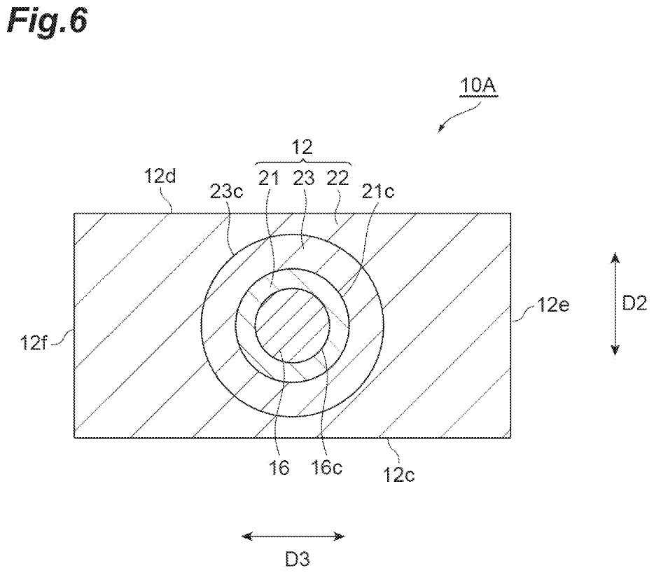

FIG. 5 is a perspective view illustrating a multilayer inductor according to a second embodiment. Illustration of the external electrodes 14A, 14B is omitted in FIG. 5. FIG. 6 is a cross-sectional view illustrating the multilayer inductor of FIG. 5. FIG. 6 shows a cross-sectional view perpendicular to the first direction D1. As illustrated in FIGS. 5 and 6, a multilayer inductor 10A according to the second embodiment is different from the multilayer inductor 10 according to the first embodiment in that the element body 12 further includes a third portion 23. The multilayer inductor 10A will be described below focusing on the difference from the multilayer inductor 10.

The third portion 23 is disposed between the first portion 21 and the second portion 22 when viewed in the first direction D1. The third portion 23 surrounds the first portion 21 when viewed in the first direction D1. The third portion 23 is provided in contact with the side surface 21c of the first portion 21. The third portion 23 is disposed spaced from the side surfaces 12c, 12d, 12e, 12f, and is not exposed at the side surfaces 12c, 12d, 12e, 12f.

The third portion 23 has a pair of end surfaces 23a, 23b and a side surface 23c. The pair of end surfaces 23a, 23b face each other in the first direction D1. The end surface 23a is exposed at the end surface 12a and is covered by the external electrode 14A. The end surface 23b is exposed at the end surface 12b and is covered by the external electrode 14B. The side surface 23c extends in the first direction D1 so as to connect the pair of end surfaces 23a, 23b. The third portion 23 has a cylindrical shape inside of which the through conductor 16 and the first portion 21 are disposed and in which the first direction D1 is an axial direction. The side surface 23c is an outer circumferential surface of the third portion 23. The third portion 23 is disposed so as to be coaxial with the through conductor 16 and the first portion 21. The third portion 23 has an outer diameter, for example, of 0.7 mm. In this case, the first portion 21 has an outer diameter, for example, of 0.55 mm. The third portion 23 covers the entire region of the side surface 21c with a uniform thickness.

The third portion 23 is disposed in the center portion of the element body 12 in the second direction D2 and the center portion of the element body 12 in the third direction D3. That is, a separation distance between the third portion 23 and the side surface 12c is equal to a separation distance between the third portion 23 and the side surface 12d. A separation distance between the third portion 23 and the side surface 12e is equal to a separation distance between the third portion 23 and the side surface 12f. The second portion 22 is disposed outward of the first portion 21 and the third portion 23, and surrounds the first portion 21 and the third portion 23 when viewed in the first direction D1. The second portion 22 is provided in contact with the side surface 23c of the third portion 23.

The first portion 21, the second portion 22, and the third portion 23 have magnetic permeabilities different from each other. In this embodiment, the magnetic permeability of the third portion 23 is higher than the magnetic permeability of the first portion 21 and lower than the magnetic permeability of the second portion 22.

The DC superimposition characteristics can also be improved in the multilayer inductor 10A since the first portion 21 and the second portion 22 have different magnetic permeabilities from each other. The magnetic permeability of the third portion 23 is higher than the magnetic permeability of the first portion 21 and lower than the magnetic permeability of the second portion 22, so that impedance can be adjusted. Consequently, improvement of the DC superimposition characteristics and ensuring of the impedance are both facilitated in the multilayer inductor 10A.

### Third Embodiment

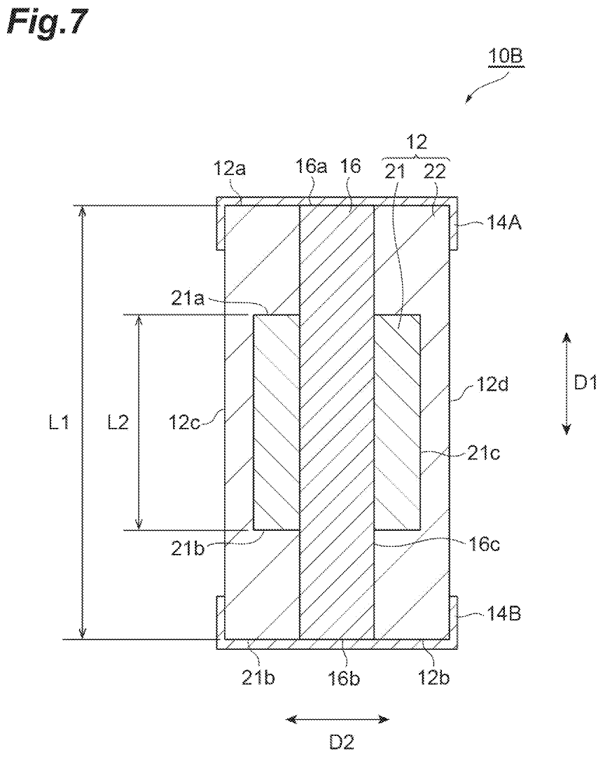

FIG. 7 is a cross-sectional view illustrating a multilayer inductor according to a third embodiment. FIG. 7 shows a cross-sectional view perpendicular to the third direction D3. As illustrated in FIG. 7, a multilayer inductor 10B according to the third embodiment is different from the multilayer inductor 10 according to the first embodiment in that the length L2 is less than the length L1. The multilayer inductor 10B will be described below focusing on the difference from the multilayer inductor 10.

The first portion 21 covers a portion of the region of the side surface 16c in the first direction D1, and not the entire region of the side surface 16c. The first portion 21 is disposed spaced from the pair of end surfaces 12a, 12b. The pair of end surfaces 21a, 21b is covered by the second portion 22, and is not exposed at the pair of end surfaces 12a, 12b. The first portion 21 is disposed in a center portion of the element body 12 in the first direction D1. That is, a separation distance between the first portion 21 and the end surface 12a is equal to a separation distance between the first portion 21 and the end surface 12b.

The DC superimposition characteristics can also be improved in the multilayer inductor 10B since the first portion 21 and the second portion 22 have different magnetic permeabilities from each other. The volume of the first portion 21 changes by changing the length L2 of the first portion 21, so that the DC superimposition characteristics also change. Thus, the range of impedance values that can be obtained is widened, which enables adjustment of the impedance according to the intended use. The entirety of the first portion 21 is disposed inside the element body 12 and not exposed at outer surfaces of the element body 12, so that stretching of the plating is more reliably suppressed.

### Fourth Embodiment

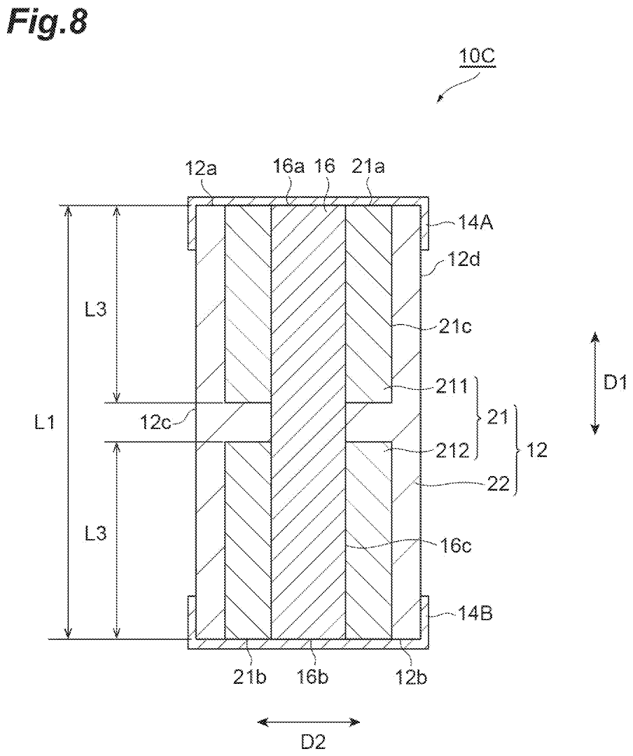

FIG. 8 is a cross-sectional view illustrating a multilayer inductor according to a fourth embodiment. FIG. 8 shows a cross-sectional view perpendicular to the third direction D3. As illustrated in FIG. 8, a multilayer inductor 10C according to the fourth embodiment is different from the multilayer inductor 10 according to the first embodiment in that the first portion 21 includes a pair of divided portions 211, 212. The multilayer inductor 10C will be described below focusing on the difference from the multilayer inductor 10.

The pair of divided portions 211, 212 is disposed spaced from each other in the first direction D1. The second portion 22 is disposed between the pair of divided portions 211, 212. The pair of divided portions 211, 212 have the same shape. The divided portion 211 includes the end surface 21a and is exposed at the end surface 12a. The divided portion 212 includes the end surface 21b and is exposed at the end surface 12b. A length L3 of each of the divided portions 211, 212 in the first direction D1 is less than the length L1. The length L3 is less than half of the length L1.

The DC superimposition characteristics can also be improved in the multilayer inductor 10C since the first portion 21 and the second portion 22 have different magnetic permeabilities from each other. The volume of the first portion 21 (i.e., a total of the volume of the divided portions 211, 212) changes by changing the length of the first portion 21 (i.e., a total of the length L3 of the divided portions 211, 212), so that the DC superimposition characteristics also change. Thus, the range of impedance values that can be obtained is widened, which enables adjustment of the impedance according to the intended use.

### Fifth Embodiment

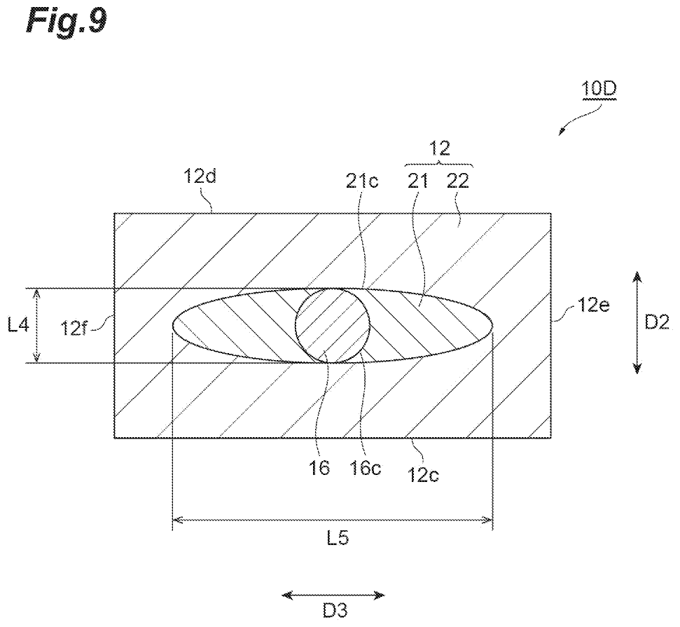

FIG. 9 is a cross-sectional view illustrating a multilayer inductor according to a fifth embodiment. FIG. 9 shows a cross-sectional view perpendicular to the first direction D1. As illustrated in FIG. 9, a multilayer inductor 10D according to the fifth embodiment is different from the multilayer inductor 10 according to the first embodiment in that an outer edge of the first portion 21 when viewed in the first direction D1 has an elliptical shape, and not a circular shape. The multilayer inductor 10D will be described below focusing on the difference from the multilayer inductor 10.

The outer edge of the first portion 21 when viewed in the first direction D1 has an elliptical shape in which the third direction D3 is a long axis direction and the second direction D2 is a short axis direction. A length L5 of the first portion 21 in the long side direction (i.e., third direction D3) of the pair of end surfaces 12a, 12b is greater than a length L4 of the first portion 21 in the short side direction (i.e., second direction D2) of the pair of end surfaces 12a, 12b. The length L4 is equal to the diameter of the through conductor 16. The length L4 may be greater than the diameter of the through conductor 16.

It can be said that the first portion 21 is disposed such that a longitudinal direction (i.e., third direction D3) of the first portion 21 follows along a longitudinal direction (i.e., third direction D3) of the element body 12 when viewed in the first direction D1. Assuming that an aspect ratio is the ratio of a length in the longitudinal direction to a length in a transverse direction, an aspect ratio of the first portion 21 (i.e., ratio of the length L5 to the length L4) when viewed in the first direction D1 may be equal to an aspect ratio of the element body 12 (i.e., ratio of the length of the element body 12 in the third direction D3 to the length of the element body 12 in the second direction D2).

The DC superimposition characteristics can also be improved in the multilayer inductor 10D since the first portion 21 and the second portion 22 have different magnetic permeabilities from each other. The longitudinal direction of the first portion 21 coincides with the longitudinal direction of the element body 12 when viewed in the first direction D1. Additionally, the length L5 is greater than the length L4. Consequently, the thickness of the second portion 22, that is, the distances from the side surfaces 12c, 12d, 12e, 12f to the side surface 21c of the first portion 21 when viewed in the first direction D1 are more uniform compared to the multilayer inductor 10. Thus, magnetic flux concentrates on a portion of the element body 12 in the multilayer inductor 10D, so that magnetic saturation is suppressed. As a result, the DC superimposition characteristics can further be improved.

To confirm the effects of the embodiments above, the DC superimposition characteristics of the multilayer inductors according to examples and comparative examples were evaluated by simulation. It should be noted that the present invention is not limited to these examples.

A multilayer inductor according to a first example has a configuration corresponding to that of the multilayer inductor 10 according to the first embodiment. A multilayer inductor according to a second example has a configuration corresponding to that of the multilayer inductor 10D according to the fifth embodiment.

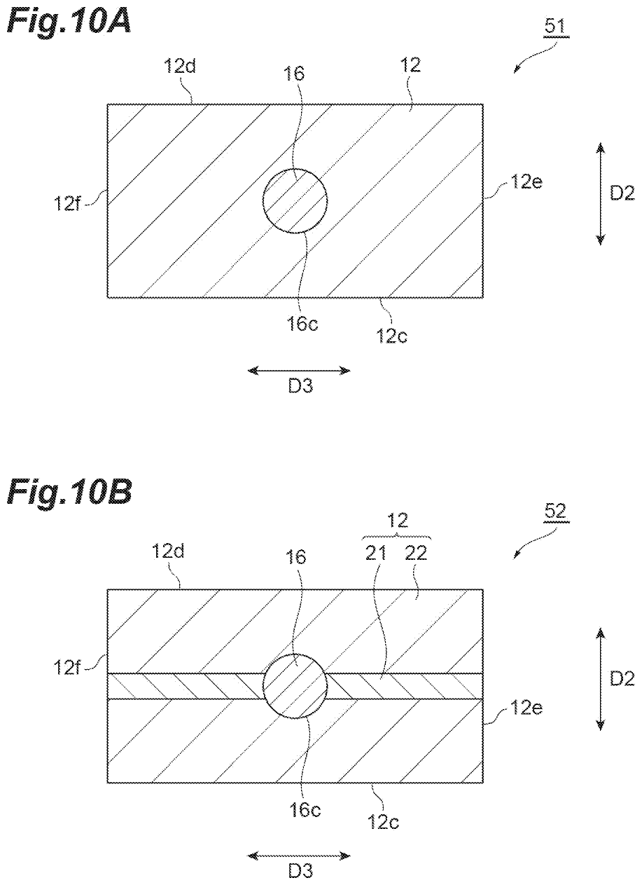

FIG. 10A is a cross-sectional view illustrating a multilayer inductor according to a first comparative example. As illustrated in FIGS. 10A and 3, the main difference between a multilayer inductor 51 according to the first comparative example and the multilayer inductor 10 according to the first embodiment is in that in the multilayer inductor 10, the element body 12 is formed of the first portion 21 and the second portion 22 having different magnetic permeabilities from each other, whereas in the multilayer inductor 51, the entirety of the element body 12 is formed of a magnetic material having the same magnetic permeability.

FIG. 10B is a cross-sectional view illustrating a multilayer inductor according to a second comparative example. As illustrated in FIGS. 10B and 3, the main difference between a multilayer inductor 52 according to the second comparative example and the multilayer inductor 10 according to the first embodiment is in the shape of the first portion 21. In the multilayer inductor 10, the first portion 21 covers the entire region of the side surface 16c of the through conductor 16, and is not exposed at the side surfaces 12c, 12d, 12e, 12f. However, in the multilayer inductor 52, the first portion 21 covers only a portion of the region of the side surface 16c of the through conductor 16, and is exposed at the side surfaces 12e, 12f.

In the multilayer inductor 52, the length of the first portion 21 in the second direction D2 is less than the diameter of the through conductor 16. The first portion 21 is disposed on both sides of the through conductor 16 in the third direction D3. The first portion 21 has a rectangular plate shape in which the second direction D2 is a thickness direction, and reaches from the through conductor 16 to the side surfaces 12e, 12f. The first portion 21 covers a region of the side surface 16c that faces the side surface 12e and a region of the side surface 16c that faces the side surface 12f. The remainder of the side surface 16c is exposed from the first portion 21.

In the multilayer inductors according to the first example, the second example, the first comparative example, and the second comparative example, the dimensions of the element body is length 2.5 mm×width 2 mm×thickness 0.85 mm, and the diameter of the through conductor is 0.4 mm. The inductances when direct currents (IDC) of 0 A, 0.5 A, 1 A, 2 A, 3 A, 4 A, and 5 A were applied to each of the multilayer inductors were obtained by simulation.

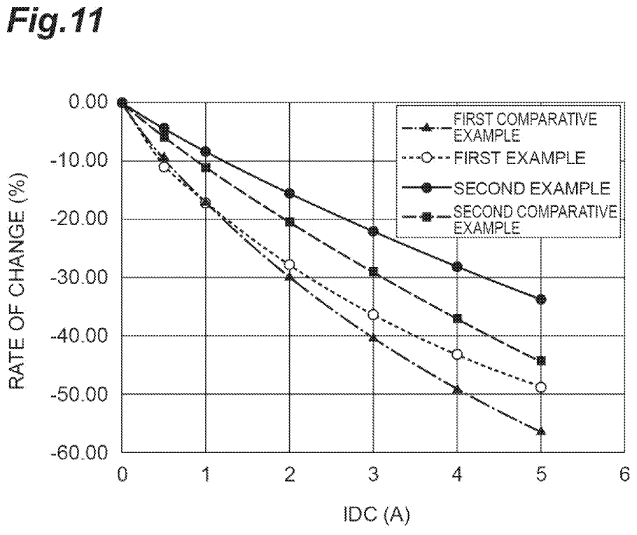

FIG. 11 is a graph illustrating results of simulation of DC superimposition characteristics. The horizontal axis of FIG. 11 represents the values (A) of the direct currents. The vertical axis of FIG. 11 represents the rates of change (%) of the inductances. The inductance decreases as the direct current increases. The rate of change of the inductance is expressed as a percentage based on the inductance when the amount of change of the inductance is 0 A (i.e., rate of change (%) of inductance=amount of change of inductance/inductance at 0 A).

As illustrated in FIG. 11, it was confirmed that the DC superimposition characteristics of the multilayer inductors according to the first example and the second example can be improved compared to the multilayer inductor according to the first comparative example. In the multilayer inductor according to the second comparative example, although the DC superimposition characteristics can be improved more than in the multilayer inductor according to the first example, stretching of the plating cannot be suppressed since the first portion is exposed at the side surfaces of the element body.

Although the embodiments of the present invention have been described above, the present invention is not necessarily limited to the embodiments above, and various modifications are possible without departing from the gist thereof.

The pair of end surfaces 12a, 12b may have a square shape. In this case, the through conductor 16 and the outer edge of the first portion 21 may have a circular shape when viewed in the first direction D1. Alternatively, the through conductor 16 and the outer edge of the first portion 21 may have a square shape when viewed in the first direction D1. Consequently, the thickness of the second portion 22, that is, the separation distances between the side surfaces 12c, 12d, 12e, 12f and the side surface 21c of the first portion 21 when viewed in the first direction D1 will be more uniform compared to the multilayer inductor 10. This facilitates the distribution of the magnetic flux throughout the entirety of the element body 12. Thus, the magnetic flux concentrates on a portion of the element body 12, so that magnetic saturation is suppressed. As a result, the DC superimposition characteristics can further be improved.

In the multilayer inductor 10, the magnetic permeability of the first portion 21 may be higher than the magnetic permeability of the second portion 22. In this case, although the DC superimposition characteristics will deteriorate compared to the case in which the magnetic permeability of the first portion 21 is lower than the magnetic permeability of the second portion 22, an initial L value will increase. That is, the impedance value can be adjusted by differentiating between cases in which the magnetic permeability of the first portion 21 is higher than and lower than the magnetic permeability of the second portion 22.

Although the first portion 21 is spaced from the pair of end surfaces 12a, 12b in the multilayer inductor 10B, the first portion 21 may be exposed at the end surface 12a or the end surface 12b. The divided portions 211, 212 may be spaced respectively from the end surfaces 12a, 12b in the multilayer inductor 10C. The first portion 21 may have three or more divided portions spaced from each other in the first direction D1 in the multilayer inductor 10C. The plurality of the divided portions may have different shapes from each other.

The embodiments and variations above may be combined as appropriate.

What is claimed is:

1. A multilayer inductor comprising:
an element body having a pair of end surfaces facing each other, and a side surface extending in a facing direction of the pair of end surfaces in such a way as to connect the pair of end surfaces; and
a through conductor disposed inside the element body and extending in the facing direction,
wherein the element body includes a first portion surrounding the through conductor and a second portion positioned outward of the first portion, when viewed in the facing direction,
wherein the first portion is disposed spaced from the side surface, and
wherein the first portion and the second portion have different magnetic permeabilities from each other.

2. The multilayer inductor according to claim 1, wherein the magnetic permeability of the first portion is lower than the magnetic permeability of the second portion.

3. The multilayer inductor according to claim 2,
wherein the element body further includes a third portion disposed between the first portion and the second portion, and
wherein the third portion has a magnetic permeability that is higher than the magnetic permeability of the first portion and lower than the magnetic permeability of the second portion.

4. The multilayer inductor according to claim 1, wherein the element body has a plurality of element body layers stacked in the facing direction.

5. The multilayer inductor according to claim 1, wherein a length of the first portion in the facing direction is equal to a length of the through conductor in the facing direction.

6. The multilayer inductor according to claim 1, wherein the first portion is disposed such that a longitudinal direction of the first portion follows along a longitudinal direction of the element body when viewed in the facing direction.

7. The multilayer inductor according to claim 1,
wherein the pair of end surfaces has a rectangular shape, and
wherein a length of the first portion in a long side direction of the pair of end surfaces is greater than a length of the first portion in a short side direction of the pair of end surfaces.

8. The multilayer inductor according to claim 1,
wherein the pair of end surfaces has a square shape, and
wherein the through conductor and the first portion each has a circular or square shape when viewed in the facing direction.

9. The multilayer inductor according to claim 7, wherein the first portion has a a circular shape and the through conductor has an elliptical shape when viewed in the facing direction.

10. The multilayer inductor according to claim 9, wherein a length of the first portion in the short side direction is equal to a length of the through conductor in the short side direction.

11. The multilayer inductor according to claim 1, wherein the through conductor has a columnar shape in which the facing direction is an axial direction.

12. The multilayer inductor according to claim 1, wherein the first portion is in contact with the through conductor.

13. The inductor according to claim 1, wherein the first portion is disposed spaced from the pair of end surfaces.

14. The inductor according to claim 1, further comprising a pair of external electrodes provided on the pair of end surfaces.

15. A multilayer inductor comprising:
an element body having a pair of end surfaces facing each other, and a side surface extending in a facing direction of the pair of end surfaces in such a way as to connect the pair of end surfaces;
a through conductor disposed inside the element body and extending in the facing direction; and
a pair of external electrodes provided on the pair of end surfaces,
wherein the element body includes a first portion surrounding the through conductor and a second portion positioned outward of the first portion, when viewed in the facing direction,
wherein the first portion is disposed spaced from the side surface, and
wherein the first portion and the second portion have different magnetic permeabilities from each other.
